(19) United States
(12) Patent Application Publication
(10) Pub. No.: US 2013/0088110 A1
(43) Pub. Date: Apr. 11, 2013

(54) SMT System

(71) Applicant: Michael Charles Bertsch, Citrus Heights, CA (US)

(72) Inventor: Michael Charles Bertsch, Citrus Heights, CA (US)

(21) Appl. No.: 13/269,105

(22) Filed: Oct. 7, 2011

(51) Int. Cl. H02K 47/00; H02N 11/00

(52) U.S. Cl. 310/113; 74/DIG. 9

(57) ABSTRACT

The SMT System works like water paddle or windmill only instead of using wind or water as propulsion the unit uses the magnetic repelling forces of South North and North South magnetic fields to propel a Turbine. A magnetic beam array is located at the base of the system. The magnets inside the magnetic beam array are pole oriented to the South North. The magnetic beam array and its adjustable arm point at the generators flywheel flipper arm that pass by on each rotation. Each flywheel flipper has an attached magnet embedded on each tip of its channels. The magnets embedded into the flywheel flipper arms poles are oriented to the North South creating a repelling force that turns the Flywheel Flipper arm and rotates the low speed shaft on the Turbine creating electricity.

### BRIEF DESCRIPTION OF DRAWINGS

FIG. 1 Elevated view of the SMT system unit.

FIG. 2 Modified front view of the magnetic beam array and its adjustable arm that point at the generators fly wheel/flipper arm.

FIG. 3 Modified side view of the low speed shaft, magnetic beam array, adjustable arm that point at the generators fly wheel/flipper arm.

FIG. 4 Side view of magnetic beam array.

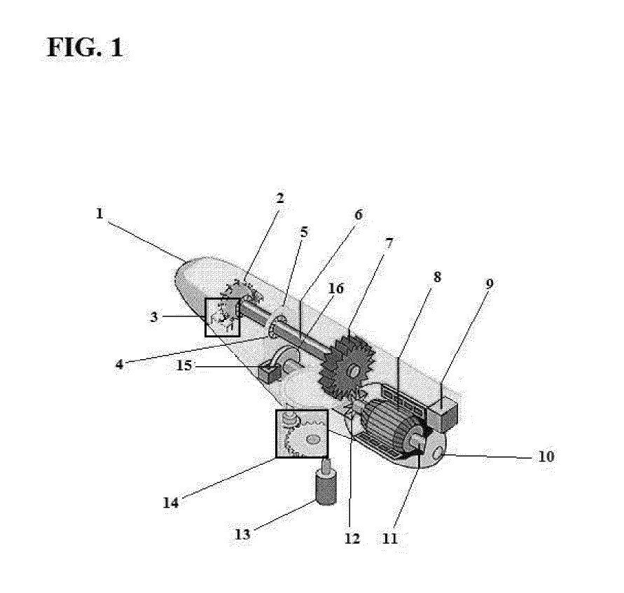

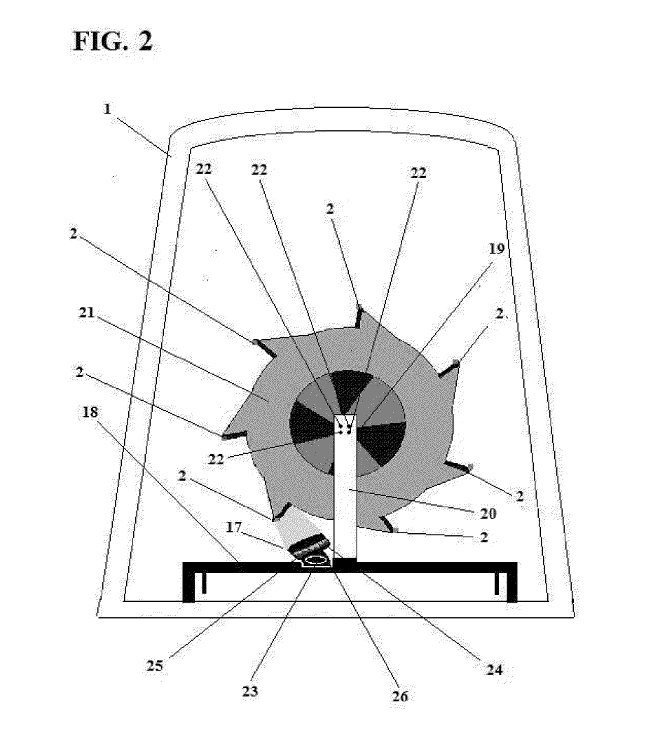

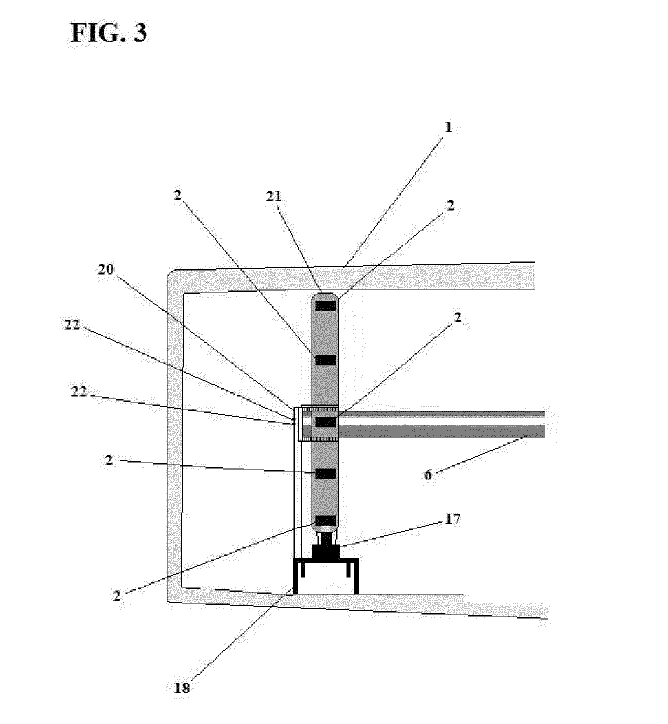

SMT plastic housing for invention. Shown in FIG. 1, FIG. 2, FIG. 3

Flywheel/flipper has an attached Samarium Cobalt magnet imbedded on Each tip of its channels. Shown in FIG. 1, FIG. 2, FIG. 3

Boxed view: The magnets inside the magnetic beam array are pole oriented to the South North. The magnetic beam array and its adjustable arm point at the generators fly wheel/flipper arm that pass by on each rotation. Each fly wheel/flipper has an attached Samarium Cobalt magnet imbedded on each tip of its channels. The magnets imbedded into the flywheel/flipper arms poles are oriented to the North South creating a repelling force that turns the Fly wheel/Flipper arm and rotates the low speed shaft on the turbine. Shown in FIG. 1

Baring ring for stabilizing low speed shaft. Shown in FIG. 1

Low speed shaft stabilizer and housing. Shown in FIG. 1

Low speed shaft. Shown in FIG. 1, FIG. 3

Rotating low speed shaft rotates upper Gear box. Gear box rotation propels lower gear box that intern propels generator. Shown in FIG. 1

SMT Generator. Shown in FIG. 1

Controller and electrical start and stop housing. Shown in FIG. 1

High speed shaft, tip and housing. Shown in FIG. 1

High speed shaft. Shown in FIG. 1

lower gear box. Shown in FIG. 1

Yaw motor. Shown in FIG. 1

Yaw Drive. Shown in FIG. 1

Break and electronic housing. Shown in FIG. 1

Disc break. Shown in FIG. 1

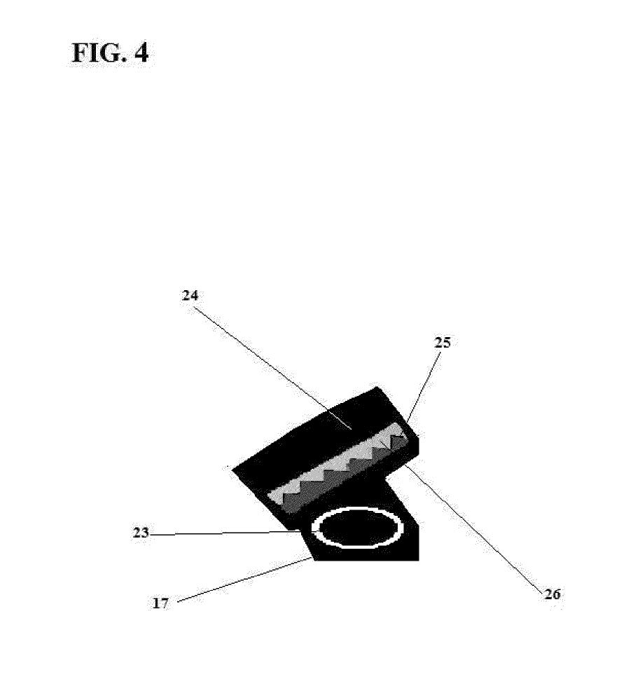

Adjustable magnetic arm. Shown in FIG. 2, FIG. 3, FIG. 4

Magnetic beam array and its adjustable arm, Flywheel/flipper arm stand. Shown in FIG. 2, FIG. 3

Supported housing for low speed shaft. Shown in FIG. 2

Low speed shaft support post with hub. Support post is connected and bolted to stand. Shown in FIG. 2, FIG. 3

Ceramic flywheel/flipper arms. Shown in FIG. 2, FIG. 3

Bolted hub. Shown in FIG. 2, FIG. 3

Magnetic beam adjustable arm. Shown in FIG. 2, FIG. 4

Angled containment cone. Houses the samarium cobalt magnets. Shown in FIG. 2, FIG. 4

Samarium cobalt magnets array. This view is transparent to show the array off magnets incased in the magnetic beam housing. Shown in FIG. 2, FIG. 4

Lower portion containment cone that has thicker shield. Houses the samarium cobalt magnets. Shown in FIG. 2, FIG. 4

1) The structure for a magnetic turbine, subsequently as shown and described.
